(19) United States
(12) Patent Application Publication
(10) Pub. No.: US 2023/0123572 A1
(43) Pub. Date: Apr. 20, 2023

(54) APPARATUS, SYSTEM AND METHOD FOR SHIPPING LABEL APPLICATION

(71) Applicant: Van Loi Le, Mission Viejo, CA (US)

(72) Inventor: Van Loi Le, Mission Viejo, CA (US)

(21) Appl. No.: 17/504,417

(22) Filed: Oct. 18, 2021

(51) Int. Cl. B65C 9/40; B25J 9/00; G01B 21/20; B65C 9/02; B65C 9/46; B65C 9/26; G06K 7/14

(52) U.S. Cl. CPC B65C 9/40; B25J 9/0093; G01B 21/20; B65C 9/02; B65C 9/46; B65C 9/26; G06K 7/1413; B25J 15/0616

(57) ABSTRACT

An apparatus for an efficient label application comprising a conveyor belt; a barcode reader that is disposed above a conveyor belt and attached to a first cross beam; a 3D profiler that is disposed above said conveyor belt and attached to a second cross beam, and records size, shape, and orientation of a shipping package; a first plexiglass shield that comprises a light curtain; wherein said first plexiglass shield and light curtain protect a robotic arm's operating space on one side of said conveyor belt; a second plexiglass shield that protects said robotic arm's foot; a printer that is disposed next to said robotic arm; two upward facing fans that are disposed between said printer and said robotic arm, and, together, create an air cushion; a third plexiglass shield that protects said robotic arm, air cushion, and printer on second side of said conveyor belt; said first plexiglass shield, third plexiglass shied, and said conveyor belt define and protect a critical zone of said robotic arm's operating space; a printer control panel that is mounted on said third plexiglass shield; an operator control panel that allows said apparatus to be started, stopped, and calibrated, and is mounted on said third plexiglass shield.

### FIELD OF INVENTION

The present application relates generally to improved automatic apparatuses, systems, and methods for speedy label application to shipping boxes. More particularly, it relates to the use of a multidimensional robotic arm to evenly apply the label regardless of the orientation of the box.

### BACKGROUND OF THE INVENTION

Ever since Amazon and other online retailers introduced the world to ecommerce in the early 2000s, there has been a dramatic shift in customer expectations and behaviors. This shift increased exponentially in mid-2020, as the COVID-19 pandemic kept people home and avoiding in-store purchases to reduce contact with others. Global ecommerce in 2021 was over $4 billion, doubling the 2018 number of approximately $2 billion, and an estimated 165 billion packages are shipped in the United States each year. Worldwide, approximately 2.14 billion people purchase goods online.

As more and more customers shift to ecommerce for more and more of their purchases, and the number of online retailers grow, shippers must move ever faster to get their packages en route as quickly as possible after the order is placed. One of the most important reasons customers choose a given retailer is the shipping speed, and they will often abandon their order if the delivery will take more than a few days. From two-day shipping to next-day to same-day, customers have grown accustomed to a slew of rapid delivery options made available by the giants of ecommerce. They want what they want, and they want it as quickly as possible. If a retailer is not capable of meeting that demand, the customer is more than capable of turning elsewhere to find someone who can.

Thus, it is desirable for a solution to speedy and automatic application of shipping labels to packages to allow shippers to more quickly respond to the ever-growing demand.

### OBJECTIVE OF THE INVENTION

It is an object of this invention to create a solution to automatically apply shipping labels to boxes with minimal human involvement.

It is an additional object of this invention to ensure that regardless of the orientation of the package, the shipping label will be applied to the correct place on the package and at the correct angle by use of a multidimensional robotic arm.

It is a further object of this invention to use a combination of an air cushion created by upward-facing fans and suction from the robotic arm to easily transfer the labels from the printer to the arm.

### SUMMARY OF THE INVENTION

The present invention relates to apparatuses, systems, and methods of automatic package label application.

The present invention comprises, among other components, a barcode reader, a 3D profiler, a conveyor belt, a multi-dimensional robotic arm, a cushion of air, and a label printer. The barcode reader identifies the package so that the printer will create the correct label. The 3D profiler reads the shape and orientation of the box so that the robotic arm knows where to place the label. When the label exits the printer, it floats on an air cushion created by two upward facing fans. The light curtain marks the point on the conveyor belt where the box is ready to be labeled. The robotic arm further comprises a label suction component to pick up a printed label and drop it on a moving package. Plexiglass shields protect the critical zone on either side of the conveyor belt.

The present invention further comprises intelligent software component that intelligently coordinates the components and controls the system. The software controls the volume of the cushion of air such that it can support different sized labels; i.e., 4×4, 4×6, 6×8, etc. The software further controls the conveyor belt speed such that the belt will travel 8.5 feet in 2.5 seconds, or the speed of printing a label in any given moment. The speed of the conveyor belt is adjustable.

In one aspect of the invention, an apparatus is disclosed for an efficient label application comprising: a conveyor belt; a barcode reader that is disposed above a conveyor belt and attached to a first cross beam; a 3D profiler that is disposed above the conveyor belt and attached to a second cross beam, and records size, shape, and orientation of a shipping package; a first plexiglass shield that comprises a light curtain; wherein the first plexiglass shield and light curtain protect a robotic arm's operating space on one side of the conveyor belt; a second plexiglass shield that protects the robotic arm's foot; a printer that is disposed next to the robotic arm; two upward facing fans that are disposed between the printer and the robotic arm, and, together, create an air cushion; a third plexiglass shield that protects the robotic arm, air cushion, and printer on second side of the conveyor belt; the first plexiglass shield, third plexiglass shied, and the conveyor belt define and protect a critical zone of the robotic arm's operating space; a printer control panel that is mounted on the third plexiglass shield; an operator control panel that allows the apparatus to be started, stopped, and calibrated, and is mounted on the third plexiglass shield.

In yet another aspect of the invention, a method for rapid label application comprising:
providing a conveyor belt; providing a barcode reader that is disposed above the conveyor belt and attached to a first cross beam; providing a 3D profiler that is disposed above the conveyor belt and attached to a second cross beam; Recording size, shape, and orientation of a shipping package; providing a first plexiglass shield; providing a light curtain; providing a robotic arm; wherein the first plexiglass shield and light curtain protect the robotic arm's operating space on one side of the conveyor belt; providing a second plexiglass shield that protects the robotic arm's foot; providing a printer that is disposed next to the robotic arm;
printing a shipping label; providing two upward facing fans that are disposed between the printer and the robotic arm; creating an air cushion using the two upward facing fans;
providing a third plexiglass shield that protects the robotic arm, air cushion, and printer on a side of the conveyor belt; wherein the first plexiglass shield, third plexiglass shied, and the conveyor belt define and protect a critical zone of the robotic arm's operating space; providing a printer control panel that is mounted on the third plexiglass shield; providing an operator control panel that is mounted on the third plexiglass shield and controls the barcode reader, conveyor belt, 3D profiler, robotic arm, and fans.

### BRIEF DESCRIPTION

The present invention will be understood and appreciated more fully from the following detailed description taken in conjunction with the drawings in which:

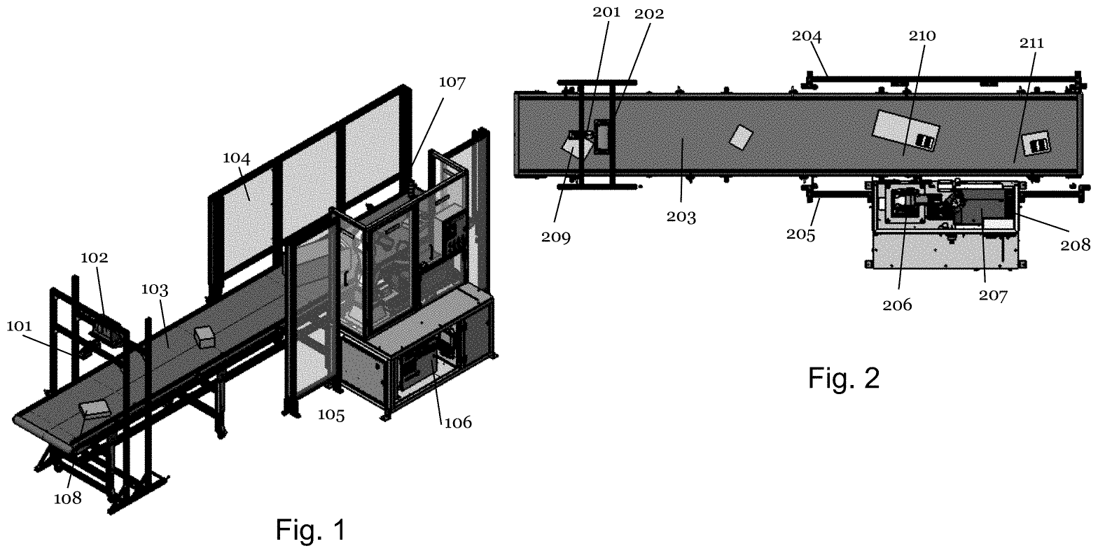

FIG. 1 is an overview, perspective view of an embodiment of the present invention.

FIG. 2 is an overview, top-down view of an embodiment of the present invention.

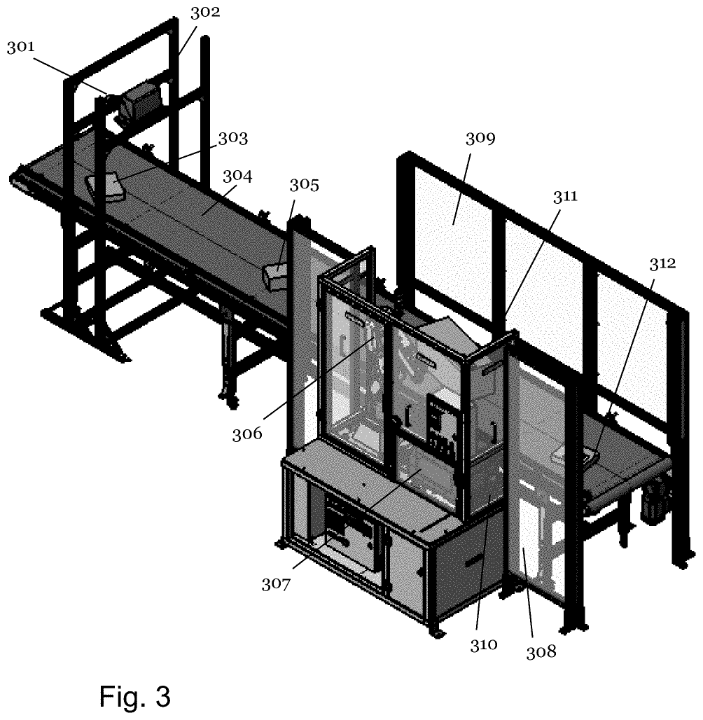

FIG. 3 is another overview, perspective view of an embodiment of the present invention.

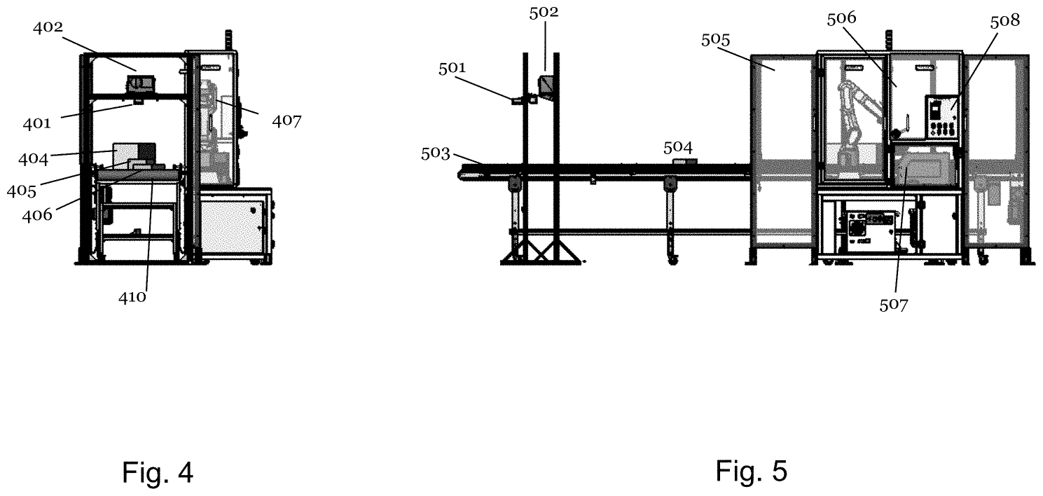

FIG. 4 is a front view of an embodiment of the present invention.

FIG. 5 is a side view of an embodiment of the present invention.

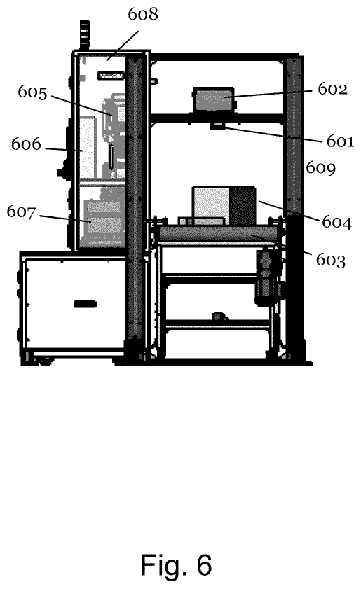

FIG. 6 is a back view of an embodiment of the present invention.

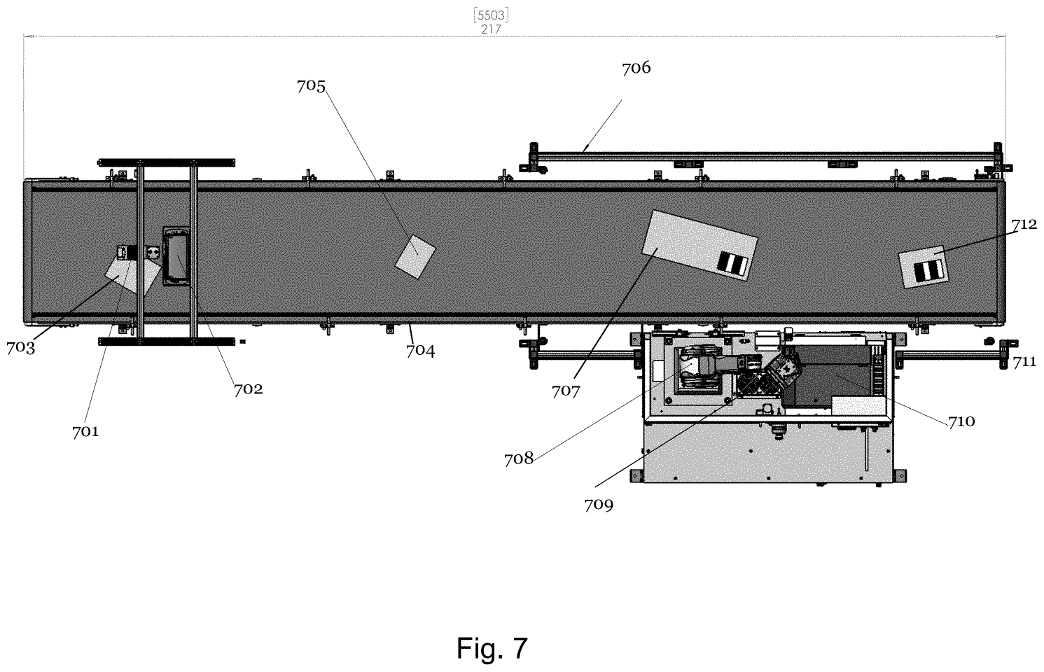

FIG. 7 is a top-down detailed view of an embodiment of the present invention. FIG. 7 illustrates the disclosed components of the present invention. As illustrated, the present invention comprises a barcode reader, a 3D profiler, a conveyor belt where products sit on and are transported toward the label applicator and printer, a multi-dimensional robotic arm, a cushion of air, and a label printer.

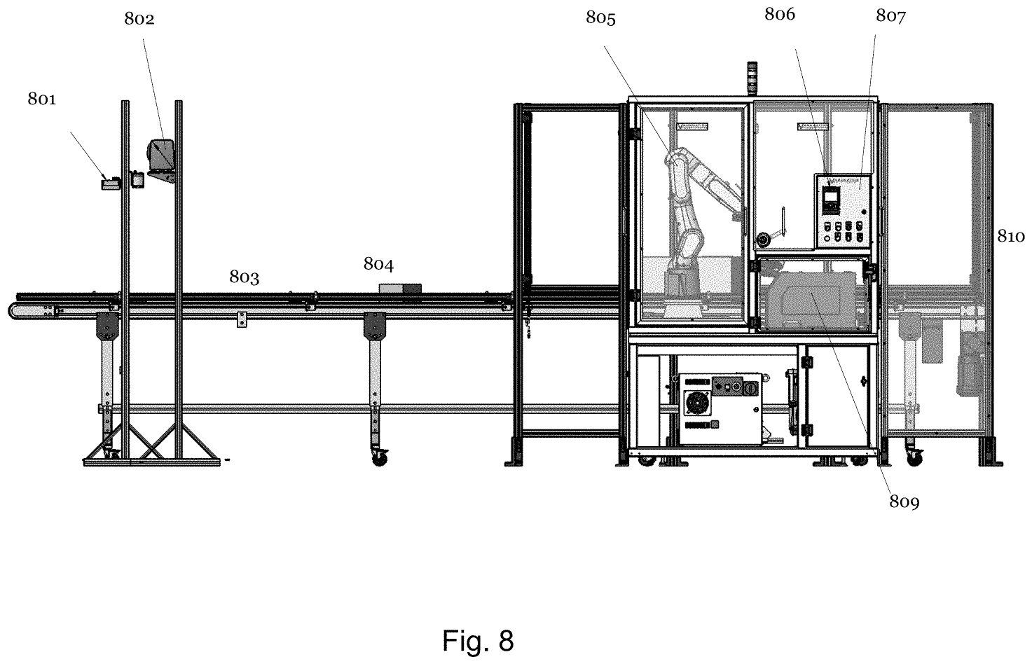

FIG. 8 is detailed side view of an embodiment of the present invention. It again illustrates the components of the present invention: a barcode reader, a 3D profiler, a conveyor belt, a multi-dimensional robotic arm, and a label printer. FIG. 8 further illustrates an embodiment of the present invention's printer control panel where system operator can start, stop, or control the system operation.

### DETAILED DESCRIPTION

The invention will be described in the context of a preferred embodiment.

FIG. 1 illustrates an overview, perspective view of the present invention. The barcode reader 101 is raised above the conveyor belt 103 and the first component underneath which the package 108 passes. The package 108 next passes underneath the 3D profiler 102, which records the size, shape, and orientation of the package 108. A plexiglass shield with light curtain 104 protects the portion of the conveyor belt 103 where the robotic arm 107 is active. A second plexiglass shield 105 protects the conveyor belt 103 on the side where the robotic arm 107 is affixed. The printer 106 sits next to the robotic arm 107.

FIG. 2 is an overview, top-down view of the present invention. The barcode reader 201 and 3D profiler are again shown with the package 209 passing underneath on the conveyor belt 203. The plexiglass shield with light curtain 204 and plexiglass shield 205 on the side with robotic arm 206 protect the portion of the conveyor belt 203 where the robotic arm 206 is active. The air cushion created by two upward facing fans 207 lies between the printer 208 and the robotic arm 206. Two packages with a properly affixed labels 210, 211 are shown moving to toward the end of the conveyor belt 203.

FIG. 3 is another overview, perspective view of the present invention. The barcode reader 301 and the 3D profiler 302 are shown, with a package 303 passing underneath on the conveyor belt 304. A second package 305 is shown further along the belt 304, illustrating how the present invention is capable of handling a continuous line of packages. The robotic arm 306 sits on the left side of the embodiment, followed by the air cushion 307 and printer 310. The plexiglass shield with light curtain 309 protects the robotic arm's 306 portion of the conveyor belt 303, and the plexiglass shield 308 protects the robotic arm 306, air cushion 307, and printer 310 on the other side. A package 311 is shown in the process of having a label applied, and another package 312 is shown at the end of the conveyor belt 304 with label properly affixed.

FIG. 4 is a front view of the present invention. The barcode reader 401 and 3D profiler 402 are shown, with a series of packages 404, 405, 406 moving along the conveyor belt 410. The robotic arm 407 can be seen preparing to affix the next label.

FIG. 5 is a side view of the present invention. The barcode reader 501 and the 3D profiler 502 are shown above the conveyor belt 503, with a package 504 about to enter the robotic arm's 506 critical zone, protected by a plexiglass shield 505. The robotic arm 506 is followed by the air cushion 507 and the label printer 508.

FIG. 6 is a back view of the present invention. The barcode reader 601 and the 3D profiler are again shown above the conveyor belt 603. A package 604 is shown moving along the conveyor belt 603. The robotic arm 605, air cushion 606, and label printer 607 are shown protected by the plexiglass shield 608. The plexiglass shield with light curtain 609 is shown on the opposite side.

FIG. 7 is a top-down detailed view of the present invention. As illustrated, the present invention comprises a barcode reader 701, a 3D profiler 702, a conveyor belt 704 where products 703, 705, 707, 712 sit and are transported toward the label applicator and printer comprising a multi-dimensional robotic arm 708, a cushion of air 709, and a label printer 710. The plexiglass with light curtain 706 is shown opposite the robotic arm 708, with a second plexiglass shield 711 protecting the robotic arm 708, air cushion 709, and printer 710.

FIG. 8 is detailed side view of the present invention. It again illustrates the components: a barcode reader 801, a 3D profiler 802, a conveyor belt 803 passing underneath the prior two items. A package 804 is shown passing along the conveyor belt 803. Next, the multi-dimensional robotic arm 805 and label printer 809 are shown, with a printer control panel 806 and operator control panel 807 where the system operator can start, stop, or otherwise control the system operation. Finally, the control panels 806 and 807 are mounted on the plexiglass shield 810.

1. An apparatus for an efficient label application comprising:
a conveyor belt;
a barcode reader that is disposed above a conveyor belt and attached to a first cross beam;
a 3D profiler that is disposed above said conveyor belt and attached to a second cross beam, and records size, shape, and orientation of a shipping package;
a robotic arm having a label suction component capable of picking up a printed label;
a first plexiglass shield that comprises a light curtain; wherein said first plexiglass shield and light curtain protect said robotic arm's operating space on one side of said conveyor belt;
a second plexiglass shield that protects said robotic arm's foot;
a printer that is disposed next to said robotic arm;
two upward facing fans, calibrated to generate sufficient airflow to float said printed label, are disposed between said printer and said robotic arm, and, together, create an air cushion, so as to keep said printed label floating after it exits said printer whereby allowing said robotic arm to pick up said printed label; a third plexiglass shield that protects said robotic arm, air cushion, and printer on second side of said conveyor belt;
said first plexiglass shield, third plexiglass shied, and said conveyor belt define and protect a critical zone of said robotic arm's operating space;
a printer control panel that is mounted on said third plexiglass shield;
an operator control panel that allows said apparatus to be started, stopped, and calibrated, and is mounted on said third plexiglass shield.

2. A method for rapid label application comprising:
providing a conveyor belt;
providing a barcode reader that is disposed above said conveyor belt and attached to a first cross beam;
providing a 3D profiler that is disposed above said conveyor belt and attached to a second cross beam; Recording size, shape, and orientation of a shipping package;
providing a first plexiglass shield;
providing a light curtain;
providing a robotic arm having a label suction component capable of picking up a printed label;
wherein said first plexiglass shield and light curtain protect said robotic arm's operating space on one side of said conveyor belt;
providing a second plexiglass shield that protects said robotic arm's foot;
providing a printer that is disposed next to said robotic arm;
printing a shipping label;
providing two upward facing fans calibrated to generate sufficient airflow to float said shipping label, and disposed between said printer and said robotic arm;
creating an air cushion using said two upward facing fans; whereby said air cushion keeps said shipping label floating after it exits said printer and allowing said robotic arm to pick up said printed label; providing a third plexiglass shield that protects said robotic arm, air cushion, and printer on a side of said conveyor belt;
wherein said first plexiglass shield, third plexiglass shied, and said conveyor belt define and protect a critical zone of said robotic arm's operating space;
providing a printer control panel that is mounted on said third plexiglass shield;
providing an operator control panel that is mounted on said third plexiglass shield and controls said barcode reader, conveyor belt, 3D profiler, robotic arm, and fans.
